(19) United States
(12) Patent Application Publication
(10) Pub. No.: US 2022/0408153 A1
(43) Pub. Date: Dec. 22, 2022

(54) INFORMATION PROCESSING DEVICE, INFORMATION PROCESSING METHOD, AND INFORMATION PROCESSING PROGRAM

(71) Applicant: SONY GROUP CORPORATION, Tokyo (JP)

(72) Inventors: Hajime TOMURA, Kanagawa (JP); Miki TOKITAKE, Tokyo (JP)

(73) Assignee: SONY GROUP CORPORATION, Tokyo (JP)

(21) Appl. No.: 17/777,498

(22) PCT Filed: Nov. 27, 2020
(86) PCT No.: PCT/JP2020/044303

§ 371 Date: May 17, 2022

(30) Foreign Application Priority Data
Dec. 5, 2019 (JP) 2019-220293

(51) Int. Cl. H04N 21/442; G06F 3/01; H04N 21/422

(52) U.S. Cl. CPC H04N 21/44218; G06F 3/011; H04N 21/42203; G06F 2203/011

(57) ABSTRACT

Provided is an information processing device configured to determine whether to perform modification to a detail of part of not-yet-viewed-and-listened-to content for a user, on the basis of a reaction of the user to viewed-and-listened-to content.

### TECHNICAL FIELD

The present technology relates to an information processing device, an information processing method, and an information processing program.

### BACKGROUND ART

Conventionally, content such as movies and TV programs have been provided to users in various methods and forms.

As one of the methods, proposed has been a system that distributes special content to the user in response to estimation of a predetermined area including the current position of the user as an area that makes people feel unpleasant (Patent Document 1).

### CITATION LIST

### Patent Document

Patent Document 1: International Publication Pamphlet No. WO 2019/21575

### SUMMARY OF THE INVENTION

### Problems to be Solved by the Invention

Objects and expressions that strongly affect the user's emotion are completely different from person to person. Thus, the user may have objects that he/she dislikes or objects that he/she does not want to see. In order for the user to accurately reflect his/her preference or emotion in content selection, it is necessary to select or reject by himself/herself. Thus, there is a disadvantage that the user needs to touch an option that evokes what the user dislikes or does not want to see. Further, there is no means to know in advance what is included in the content or what is not want to be seen. Thus, there is also a disadvantage that the user unexpectedly sees the content and feels unpleasant. Patent Document 1 discloses a technology of providing content to the user who feels unpleasant; however, it has not been able to solve such disadvantages.

The present technology has been made in view of such points, and an object of the present technology is to provide an information processing device, an information processing method, and an information processing program capable of providing content modified in accordance with a user's preference or emotion.

### Solutions to Problems

In order to solve the above disadvantages, a first technology is an information processing device configured to determine whether to perform modification to a detail of part of not-yet-viewed-and-listened-to content for a user, on the basis of a reaction of the user to viewed-and-listened-to content.

Further, a second technology is an information processing method including: determining whether modification is to be performed to a detail of part of not-yet-viewed-and-listened-to content for a user, on the basis of a reaction of the user to viewed-and-listened-to content.

Furthermore, a third technology is an information processing program for causing a computer to perform an information processing method including determining whether modification is to be performed to a detail of part of not-yet-viewed-and-listened-to content for a user, on the basis of a reaction of the user to viewed-and-listened-to content.

### BRIEF DESCRIPTION OF DRAWINGS

FIG. 1 is a block diagram illustrating a configuration of a content providing system 10.

FIG. 2 is a block diagram illustrating a configuration of a terminal device 100.

FIG. 3 is a block diagram illustrating a configuration of a terminal-device processing unit 120.

FIG. 4 is a block diagram illustrating a configuration of a distribution server 200.

FIG. 5 is a block diagram illustrating a configuration of an information processing device 300.

FIG. 6 explanatorily illustrates a content database 301.

FIG. 7 explanatorily illustrates objects and the number of times of aversive reaction.

FIG. 8 explanatorily illustrates a table in which aversive reaction and aversive level are associated with each other.

FIG. 9 is a flowchart of processing in the terminal device 100.

FIG. 10 is a flowchart of processing in the information processing device 300.

FIG. 11 is a flowchart of processing in the information processing device 300.

FIG. 12 explanatorily illustrates modification processing to content.

FIG. 13 explanatorily illustrates a first example of the modification processing to the content.

FIG. 14 explanatorily illustrates a fourth example of the modification processing to the content.

FIG. 15 explanatorily illustrates a second example of the modification processing to the content.

FIG. 16 explanatorily illustrates a third example of the modification processing to the content.

FIG. 17 explanatorily illustrates a fifth example of the modification processing to the content.

### MODE FOR CARRYING OUT THE INVENTION

Hereinafter, embodiments of the present technology will be described with reference to the drawings. Note that the description will be given in the following order.

### <1. Embodiments>

### [1-1. Configuration of Content Providing System 10]

### [1-2. Configuration of Terminal Device 100]

### [1-3. Configuration of Distribution Server 200]

### [1-4. Configuration of Information Processing Device 300]

### [1-5. Processing in Content Providing System 10]

### [1-5-1. Processing in Terminal Device 100]

### [1-5-2. Processing in Information Processing Device 300]

### [1-5-3. Modification Processing to Details of Content]

### <2. Applications>

### <3. Modifications>

### 1. Embodiments

### [1-1. Configuration of Content Providing System 10]

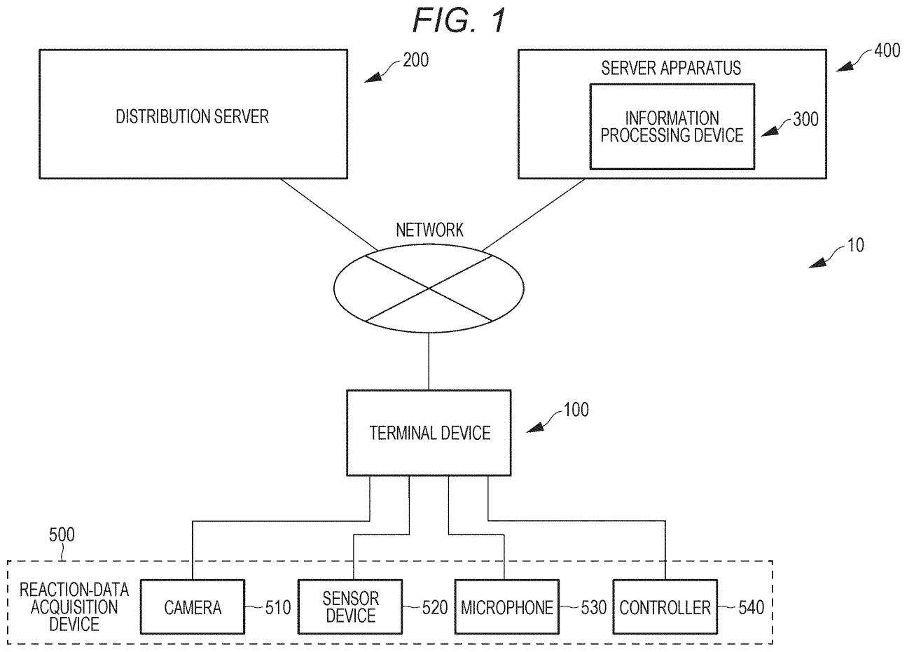

First, a configuration of a content providing system 10 according to an embodiment of the present technology will be described with reference to FIG. 1. The content providing system 10 includes a terminal device 100, a distribution server 200, and an information processing device 300. The terminal device 100 and the information processing device 300 are connected through a network such as the Internet, and the information processing device 300 and the distribution server 200 are connected through the network such as the Internet.

The terminal device 100 is a device that reproduces content for presentation to the user. Examples of the terminal device 100 include a television, a personal computer, a smartphone, a tablet terminal, a wearable device, and a head-mounted display. Further, the terminal device 100 plays a role of transmitting, to the information processing device 300, data indicating a reaction of the user to content acquired by a multifunctional reaction-data acquisition device 500. The reaction-data acquisition device 500 includes a camera 510, a sensor device 520, a microphone 530, and a controller 540.

The distribution server 200 is a server that stores, manages, and provides content to the terminal device 100, and is operated by a content provider or the like. In a case where the present technology is not used, content is directly provided from the distribution server 200 to the terminal device 100 through the network.

For example, the information processing device 300 operates in the server apparatus 400, and manages distribution of content subjected to modification processing in accordance with what the user is bad at or content that can be subjected to the modification processing, from the distribution server 200 to the terminal device 100. In the present embodiment, description will be given on the assumption that the content is moving image content. In addition, it is assumed that a target of the modification processing is an object appearing in the content. The object represents an object, an object, a target object, a target, a purpose, an object, or the like. The moving image content includes everything appearing in the content, such as a person, an animal, an insect, a plant, a living organism, an object, a liquid, food, a tool, a building, or a vehicle. The object corresponds to the detail of part of the content in the claims.

### [1-2. Configuration of Terminal Device 100]

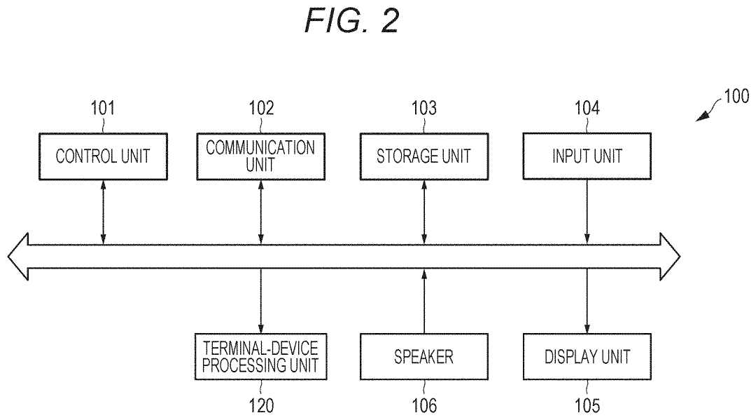

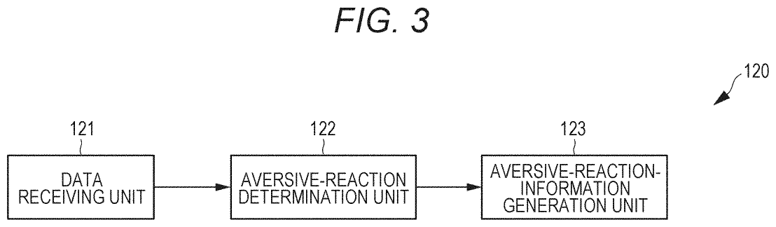

Next, a configuration of the terminal device 100 will be described with reference to FIGS. 2 and 3. The terminal device 100 includes a control unit 101, a communication unit 102, a storage unit 103, an input unit 104, a display unit 105, a speaker 106, and a terminal-device processing unit 120.

The control unit 101 includes a central processing unit (CPU), a random access memory (RAM), and a read only memory (ROM). The CPU controls the entirety of the terminal device 100 and each unit thereof by performing various pieces of processing according to a program stored in the ROM and issuing commands.

The communication unit 102 is a communication module for transmitting and receiving data and various types of information to and from the distribution server 200 and the information processing device 300 through the network. Examples of schemes of communication include a scheme of wireless local area network (LAN), a scheme of wide area network (WAN), a scheme of wireless fidelity (WiFi), a scheme of fourth generation mobile communication system (4G)/long term evolution (LTE), and a scheme of fifth generation mobile communication system (5G), and any scheme may be used as long as it allows connection to, for example, the Internet and other devices.

The storage unit 103 is, for example, a large-capacity storage medium such as a hard disk or a flash memory. The storage unit 103 stores various applications, data, and others used by the terminal device 100.

The input unit 104 is used by the user to input various instructions and others to the terminal device 100. In response to an input from the user to the input unit 104, a control signal corresponding to the input is generated and supplied to the control unit 101. Then, the control unit 101 performs various types of processing corresponding to the control signal. In addition to physical buttons, the input unit 104 includes a touch panel, voice input by voice recognition, gesture input by human body recognition, and others.

The display unit 105 is a display device such as a display that displays for example, a moving image, an image/video, or a graphical user interface (GUI), as content.

The speaker 106 is an audio output device that outputs audio of content, audio of a user interface, and others.

In the present embodiment, as illustrated in FIG. 1, the reaction-data acquisition device 500 for acquiring data indicating a reaction of the user to the content is connected to the terminal device 100. The reaction-data acquisition device 500 includes the camera 510, the sensor device 520, the microphone 530, and the controller 540.

The camera 510 includes a lens, an imaging element and a video-signal processing circuit, and captures the user viewing and listening to content. An image/video captured by the camera 510 is subjected to, for example, image recognition processing, so that detected can be a reaction such as an action or a motion of the user viewing and listening to the content. Further, also detected can be biometric information such as the pulse of the user by analysis of an image including the face of the user resulting from acquisition by the camera 510 fixedly installed indoors or the like.

The sensor device 520 is a sensor that detects, by sensing, a state or a reaction of the user viewing and listening to the content. Examples of the sensor include various biometric sensors that detect biometric information such as heart rate data, blood flow data, fingerprint data, voiceprint data, face data, vein data, perspiration data, and electroencephalogram data. Further, the examples include an accelerometer and a vibration sensor that are capable of detecting a behavior of the user such as a posture or jittering, an illuminance sensor, an environmental sound sensor, a temperature sensor, and a humidity sensor that are capable of detecting the environment surrounding the user.

In a case where the sensor device 520 detects a state or reaction of the user, the device including the sensor is carried or worn by the user, for example. Such a sensor device 520 is provided in, for example, a wristwatch-type or a bracelet-type wearable device. Alternatively, even in a case where the device including the sensor is installed in the living environment of the user, the position and situation (including biometric information) of the user can also be detected.

Note that the sensor device 520 may include a processor or processing circuit for converting a signal or data acquired by the sensor into a predetermined format (for example, conversion of an analog signal into a digital signal, or encoding of image data or voice data). Alternatively, the sensor device 520 may output the acquired signal or data to the terminal device 100 without converting the signal or data into a predetermined format. In this case, the signal or data acquired by the sensor is subjected to predetermined conversion in the terminal device 100.

The microphone 530 is for collecting a voice uttered by the user viewing and listening to the content. The voice of the user collected by the microphone 530 is subjected to, for example, voice recognition processing, so that detected can be a reaction such as an action or a motion of the user viewing and listening to the content.

Further, the microphone 530 can be used by the user to input a voice to the terminal device 100. Such voice input with a voice recognition technology enables the user to perform various operations of the terminal device 100.

The controller 540 is a multifunctional input device such as a remote controller 540 for remotely operating the terminal device 100. For example, an input to the controller 540 enables the user to instruct the terminal device 100, for example, to reproduce, pause, stop, rewind, fast forward, scene skip, or volume-adjust the content. The controller 540 transmits information indicating the details of the input by the user to the terminal device 100.

Note that each function of the reaction-data acquisition device 500 may be included in the terminal device 100 or may be provided as an external device different from the terminal device 100. Further, the camera 510, some functions of the sensor device 520, the microphone 530, and the controller 540 may be provided as a single external device, for example, as a smart speaker.

The reaction-data acquisition device 500 is not limited to the camera 510, the sensor device 520, the microphone 530, and the controller 540, and thus may be any device different from them as long as the device is capable of acquiring data indicating a motion, an action, or biological reaction of the user.

As illustrated in FIG. 3, the terminal-device processing unit 120 of the terminal device 100 includes a data receiving unit 121, an aversive-reaction determination unit 122, and an aversive-reaction-information generation unit 123.

The data receiving unit 121 receives reaction data regarding the user at the time of viewing of and listening to the content transmitted from the reaction-data acquisition device 500 through the communication unit 102. The reaction data is transmitted to the terminal device 100 together with time information indicating the time when the user showed the reaction. This is used to grasp the reproduction position of the content when the user showed the reaction. In a case where the reaction-data acquisition device 500 constantly transmits reaction data to the terminal device 100 in real time, the terminal device 100 may associate the reaction data with the time information.

On the basis of the reaction data received by the data receiving unit 121, the aversive-reaction determination unit 122 determines whether or not the reaction of the user at the time of viewing of and listening to the content corresponds to aversive reaction. Whether or not the reaction of the user corresponds to the aversive reaction can be determined, for example, from determination in advance of a specific action, a motion, biometric information, or the like of the user, as aversive reaction, and checking whether or not the reaction of the user corresponds thereto.

Examples of such specific actions and motions of the user to be determined as the aversive reaction include turning off the power of the terminal device 100, stop (including pause) of the reproduction of content on the terminal device 100, fast-forwarding the playback of content, changing a channel, changing content, turning the face, looking away, closing the eyes, covering the face with the hands, jittering, clicking the tongue, uttering a specific word (such as “No” or “Disgusting”), crying, screaming and overreacting, moving, and blankly.

In addition, for biometric information such as the amount of perspiration, the body temperature, and the heart rate, a threshold is provided for each piece of biometric information. It can be determined to be the aversive reaction for the biometric information not less than the threshold. For example, it is determined to be the aversive reaction for the heart rate not less than 130.

Note that a reaction of the user can also be obtained in a complex manner from reaction data that can be acquired by the reaction-data acquisition device 500. For example, the reaction of “screaming and overreacting” can be detected in a complex manner from the motion of the user captured by the camera 510, the voice of the user collected by the microphone 530, the heart rate detected by the sensor device 520, and others.

In a case where the aversive-reaction determination unit 122 determines that the reaction of the user corresponds to the aversive reaction, the aversive-reaction-information generation unit 123 generates aversive-reaction information by associating the aversive reaction, the title and the reproduction position of the content to which the user has shown the aversive reaction. As a result, the content to which the user has shown the aversive reaction can be grasped. Further, from the reproduction position, grasped can be an object to which the user has shown the aversive reaction.

Note that the title and the reproduction position of the content to which the user has shown the aversive reaction can be acquired on the basis of the time information associated with the reaction data. The terminal device 100 normally has a clock function, and further has a content reproduction function such as a moving image player that is capable of grasping the reproduction position of the content in reproduction. Thus, the title and the reproduction position of the content to which the user has shown the aversive reaction can be associated using the time information associated with the reaction data.

The generated aversive-reaction information is transmitted to the information processing device 300 through the communication unit 102.

The terminal-device processing unit 120 is achieved due to execution of a program. The program may be installed in a server or the like in advance, or may be distributed by, for example, downloading or a storage medium and may be installed by an agent service provider. Moreover, the information processing device 300 may be achieved not only by the program but also by hardware having functions for the information processing device 300, such as a combination of a dedicated device and a dedicated circuit.

### [1-3. Configuration of Distribution Server 200]

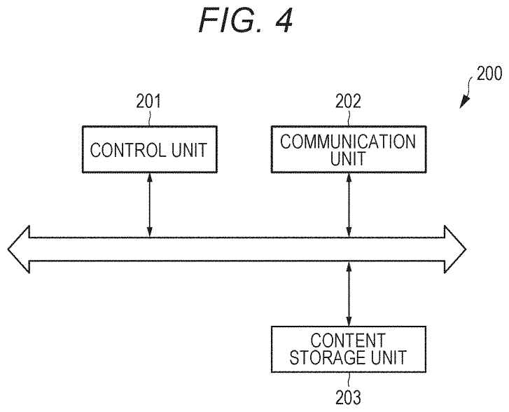

Next, a configuration of the distribution server 200 will be described with reference to FIG. 4. The distribution server 200 includes at least a control unit 201, a communication unit 202, and a content storage unit 203.

The control unit 201 includes a CPU, a RAM, and a ROM. The CPU controls the entirety of the distribution server 200 and each unit thereof by performing various pieces of processing according to a program stored in the ROM and issuing commands.

The communication unit 202 is a communication module for transmitting and receiving data and various types of information to and from the terminal device 100 and the information processing device 300 through the network. Examples of schemes of communication include a scheme of wireless LAN, a scheme of WAN, a scheme of WiFi, a scheme of 4G/LTE, and a scheme of 5G, and any scheme may be used as long as it allows connection to, for example, the Internet and other devices.

The content storage unit 203 is a large-capacity storage medium and stores data regarding content for distribution. Note that the content storage unit 203 stores and manages original content data, modified content data generated by being subjected to modification processing, and data for modification processing.

The distribution server 200 is configured as above. In response to a request, from the information processing device 300, for providing content determined by the information processing device 300, the control unit 201 reads the content from the content storage unit 203 and transmits the content to the information processing device 300 by communication through the communication unit 202. The content is transmitted to the terminal device 100 of the user through the server apparatus 400 in which the information processing device 300 operates. In addition, a request for providing the content determined by the information processing device 300 can be made to the distribution server 200, and the distribution server 200 can directly transmits the content to the terminal device 100.

Note that in the case of distribution of normal content without the information processing device 300, a request for distributing the content is made from the terminal device 100 to the distribution server 200, and the distribution server 200 directly distributes the content to the terminal device 100 through the network.

### [1-4. Configuration of Information Processing Device 300]

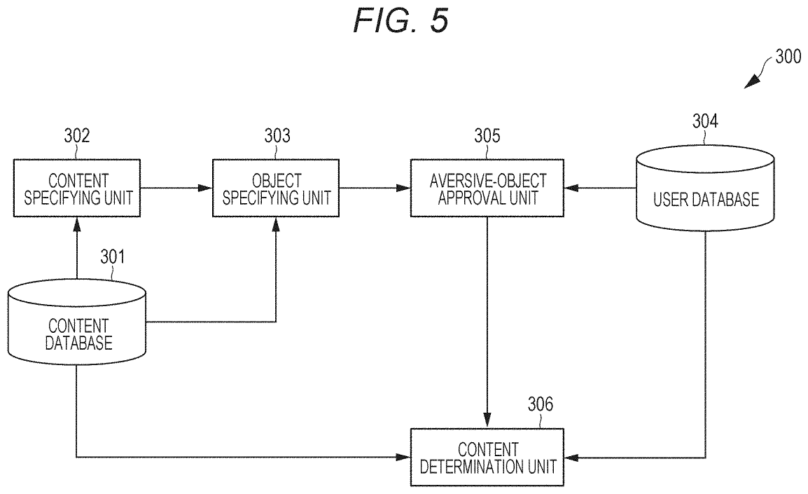

Next, a configuration of the information processing device 300 will be described with reference to FIG. 5. The information processing device 300 includes a content database 301, a content specifying unit 302, an object specifying unit 303, a user database 304, an aversive-object approval unit 305, and a content determination unit 306.

The content database 301 manages viewed-and-listened-to content that the user has viewed and listened to and information regarding content for specifying the content and the object to which the user has shown aversive reaction. Content data is subjected to analysis processing of an image, a voice, and others by machine learning, known scene analysis processing, or object detection processing, so that information regarding an object appearing for each scene can be acquired and registered into the content database 301. Note that a person may actually view and listen to content and may register information regarding the content into the content database 301.

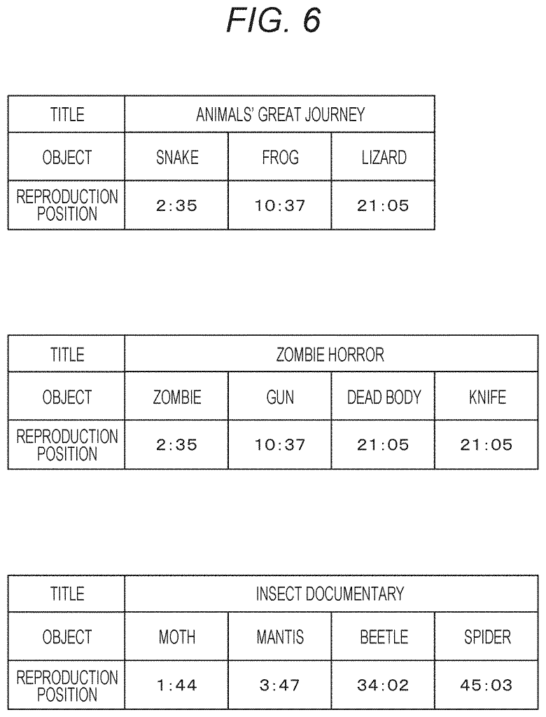

As information to be registered into the content database 301, at least as illustrated in FIG. 6, there are the title of content providable by the distribution server 200, an object appearing in the content, and information regarding the reproduction position where the object appears.

In the content database 301, the genre of the content, the list of objects that appear, information regarding modification of the content, presence or absence of modified content data in the distribution server 200, the details of modification of the modified content data, and others are registered as content information. The information regarding the modification of the content is, for example, information indicating that the entire content can be modified because the content is CG content, whether or not the content is established even if the content is modified due to the story or the structure, that only a specific portion can be modified, or that the entire content cannot be edited. The presence or absence of the modified content data in the distribution server 200 and the details of the modification of the modified content data are used in determination of content to be provided to the user. Thus, it is necessary to periodically receive information from the distribution server 200 and update the database.

Further, in the content database 301, an object appearing in the content, the reproduction position where the object appears, the rate of influence on the user, additional information by a medical worker, and others are registered as information regarding the object.

Furthermore, the content database 301 includes, as scene information, a scene-start reproduction position, a scene-end reproduction position, a list of objects that appear (name, size, color, reality (such as real or illustrated), a typical sense of aversion, and others), for example.

The content specifying unit 302 refers to the title of the viewed-and-listened-to content included in the aversive-reaction information transmitted from the terminal device 100 and the content database 301, and specifies the viewed-and-listened-to content that the user has viewed and listened to. The title information regarding the specified viewed-and-listened-to content is supplied to the object specifying unit 303.

On the basis of the title information regarding the viewed-and-listened-to content supplied from the content specifying unit 302 and the reproduction-position information included in the aversive-reaction information, the object specifying unit 303 specifies an object to which the user has shown the aversive reaction in the viewed-and-listened-to content. Information regarding the specified object (hereinafter, referred to as a specific object) is supplied to the aversive-object approval unit 305.

The user database 304 integrates the content to which the user has shown the aversive reaction, the specific object, information regarding the scene, and others and manages the result for each user. The user database 304 manages the information for each user by associating with information for identifying the user, such as user registration information in a content providing service provided by the distribution server 200 and the information processing device 300.

The information to be registered in the user database 304 further includes the name of the user, the registration information regarding the user, an image resulting from capturing of the user at the time of viewing of and listening to the content, biometric information regarding the user at the time of viewing of and listening to the content, voice data regarding utterance by the user at the time of viewing of and listening to the content, a history regarding operation on the controller 540 by the user at the time of viewing of and listening to the content, and the title of the content that the user has viewed and listened to.

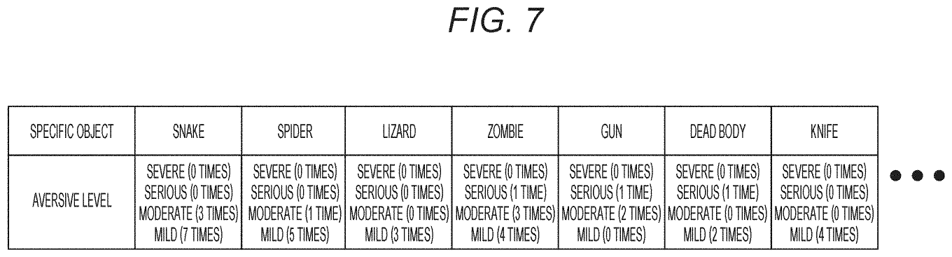

Further, as illustrated in FIG. 7, specific objects, and the level of the aversive reaction and the number of times of the aversive reaction to which the user has shown for each specific object are also registered in the user database 304. The level of the aversive reaction and the number of times of the aversive reaction to which the user has shown for each specific object are updated by the aversive-object approval unit 305.

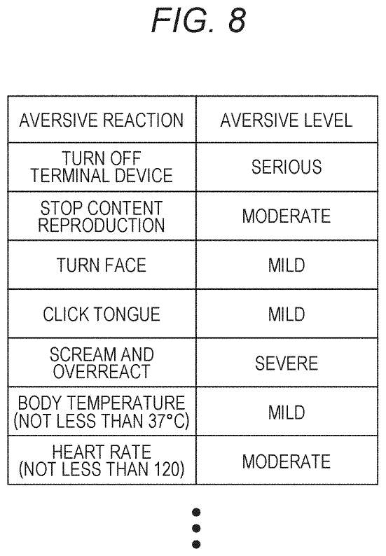

The aversive-object approval unit 305 checks whether or not a specific object is registered in the user database 304. Then, in the case of being registered, on the basis of such a table in which the aversive reaction and the aversive level are associated with each other as illustrated in FIG. 8, the number of times for aversive level for the specific object to which the user has shown the aversive reaction is updated in the user database 304. Otherwise, in a case where the specific object to which the user has shown the aversive reaction is not registered in the user database 304, the specific object to which the user has shown the aversive reaction is newly registered into the user database 304. As illustrated in FIG. 8, the aversive-level table contains the aversive reaction of the user corresponding to the aversive level.

A threshold is set in advance for the number of times for the aversive level. For example, the number of times for severe in aversive level is 1, the number of times for serious in aversive level is 3, the number of times for moderate in aversive level is 5, and the number of times for mild in aversive level is 10. Then, the aversive-object approval unit 305 updates the number of times for the aversive level in the user database 304 each time the user views and listens to the content and shows the aversive reaction, and approves, as an aversive object for the user, a specific object which number of times for the aversive level has exceeded the threshold. The aversive object is an object to be modified. Thus, due to the approval as an aversive object, it is determined that the details of not-yet-viewed-and-listened-to content to be provided to the user are modified.

For example, assuming that the threshold for the most important in aversive level is 1, if the user shows the aversive reaction as the most important in aversive level even once, the object to which the user has shown the aversive reaction has approval as an aversive object.

In addition, for example, assuming that the threshold for mild in aversive level is 10, if the user shows the aversive reaction as mild in aversive level 10 times, the object to which the user has shown the aversive reaction has approval as an aversive object.

Objects aversive for users vary depending on the country, culture, religion, and others. Thus, it is preferable to localize and set a threshold for aversive level depending on the country or region where the present technology is carried out.

The content determination unit 306 determines content to be provided to the user, on the basis of the presence or absence, in the content database 301, of modified content data in the distribution server 200, the specifics of the modification of the modified content data, the user database 304, and others. The content to be provided to the user corresponds to not-yet-viewed-and-listened-to content in the claims. Note that the provision includes not only distribution of a single piece of content to the user but also presentation of a plurality of pieces of content for recommendation.

The information processing device 300 operates in the server apparatus 400. The server apparatus 400 includes at least a control unit, a communication unit, and a storage unit similar to those of the distribution server 200. The information processing device 300 communicates with the terminal device 100 and the distribution server 200 through the communication unit of the server apparatus 400.

The information processing device 300 is achieved due to execution of a program, and the program may be installed in the server apparatus 400 in advance, or may be distributed by, for example, downloading or a storage medium and may be installed by a content provider. Further, the information processing device 300 may be achieved not only by the program but also by hardware having functions for the information processing device 300, such as a combination of a dedicated device and a dedicated circuit.

### [1-5. Processing in Content Providing System 10]

### [1-5-1. Processing in Terminal Device 100]

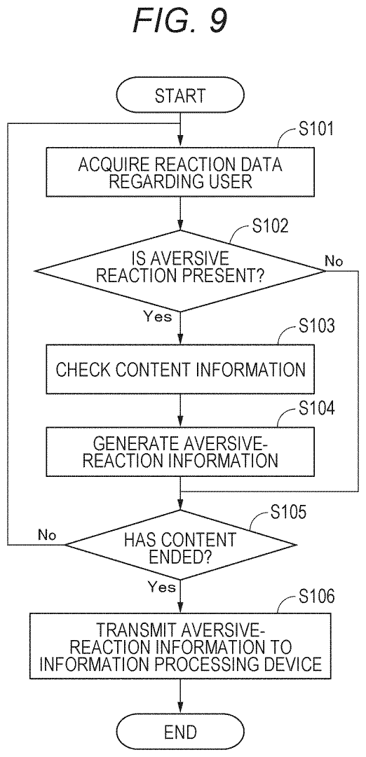

Next, processing in the content providing system 10 will be described. First, processing in the terminal device 100 will be described with reference to the flowchart of FIG. 9. This processing is processing of transmitting, to the information processing device 300, reaction data regarding the user to viewed-and-listened-to content, and as a premise, it is assumed that the user is viewing and listening to content with the terminal device 100.

First, in step S101, the data receiving unit 121 receives, from the reaction-data acquisition device 500, reaction data indicating the reaction of the user viewing and listening to the content, to the content. Examples of the reaction data include image data resulting from capturing by the camera 510, biometric data resulting from detection by the sensor device 520, voice data resulting from collection by the microphone 530, and input data to the controller 540 by the user.

Next, in step S102, the aversive-reaction determination unit 122 determines whether or not the reaction of the user to the content that the user is viewing and listening to corresponds to aversive reaction. In a case where the reaction of the user corresponds to the aversive reaction, the processing goes to step S103 (Yes in step S102).

Next, in step S103, the title of the content to which the user has shown the aversive reaction, the reproduction-position information regarding the content at the point in time when the user showed the aversive reaction, and others are checked. The title of the content can be checked with the content reproduction function of the terminal device 100. The reproduction-position information can be checked by referring to the reproduction position of the content at the point in time when the data receiving unit 121 acquired the reaction data.

Next, in step S104, the aversive-reaction-information generation unit 123 associates the type of the aversive reaction of the user, the title of the content that the user is viewing and listening to, and the reproduction-position information regarding the content at the point in time when the user showed the aversive reaction. Hereinafter, information in which the type of the aversive reaction, the title of the content, and the reproduction-position information regarding the content are associated with each other is referred to as aversive-reaction information.

Next, in step S105, it is determined whether or not the content viewed and listened to by the user has ended. In a case where the content has not ended, the processing goes to step S101, and steps S101 to S105 are repeated until the content ends (No in step S105). Otherwise, in a case where the content has ended, the processing goes to step S106 (Yes in step S105).

Then, in step S106, the aversive-reaction information is transmitted to the information processing device 300.

### [1-5-2. Processing in Information Processing Device 300]

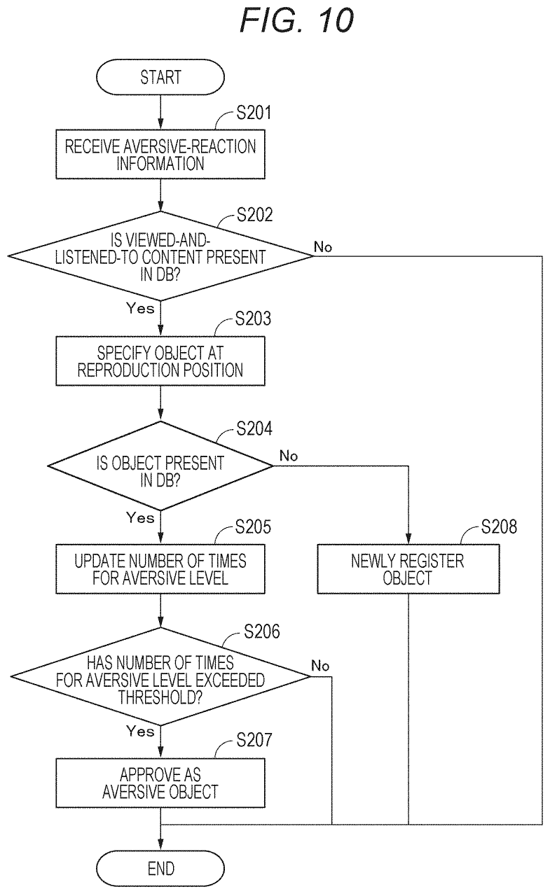

Next, processing in the information processing device 300 will be described with reference to the flowchart of FIG. 10. This processing is processing in response to the transmission of the aversive-reaction information from the terminal device 100 to the information processing device 300 described in FIG. 9.

First, in step S201, the aversive-reaction information transmitted from the terminal device 100 is received.

Next, in step S202, it is checked whether the content indicated by the aversive-reaction information, that is, the viewed-and-listened-to content that the user has viewed and listened to is present in the content database 301. In a case where the viewed-and-listened-to content is present in the content database 301, the processing goes to step S203 (Yes in step S202). Otherwise, in a case where the viewed-and-listened-to content is absent in the content database 301, the processing ends (No in step S202).

Next, in step S203, the object specifying unit 303 refers to the reproduction-position information regarding the viewed-and-listened-to content included in the aversive-reaction information, and specifies an object to which the user has shown the aversive reaction at the reproduction position of the viewed-and-listened-to content. As described above, this specified object is referred to as a specific object.

Next, in step S204, the aversive-object approval unit 305 checks whether the specific object is present in the user database 304. In a case where the specific object is present in the user database 304, the processing goes to step S205 (Yes in step S204). Otherwise, in a case where the specific object is absent in the user database 304, the processing goes to step S208 (No in step S204), and the specific object is newly registered into the user database 304.

Next, in step S205, the aversive-object approval unit 305 updates the number of times for the aversive level in the user database 304 for the specific object.

Next, in step S206, the aversive-object approval unit 305 determines whether or not the number of times for the aversive level in the user database 304 has exceeded a threshold. In a case where the number of times for the aversive level has exceeded the threshold, the processing goes to step S207 (Yes in step S206), and the specific object has approval as an aversive object. The aversive object is an object to be modified. Thus, due to the approval as an aversive object, it is determined that the details of content are modified. Information regarding the aversive object is registered into the user database 304 for each user.

Otherwise, in a case where the number of times for the aversive level does not exceed the threshold in step S206, the processing ends without approval of the specific object as an aversive object (No in step S206).

The processing in the terminal device 100 illustrated in FIG. 9 and the processing in the information processing device 300 illustrated in FIG. 10 are performed each time the user views and listens to content, whereby information regarding an object to which the user is averse is accumulated. This arrangement enables presentation, to the user, of content not including an object to which the user is averse.

Note that in a case where a plurality of objects appears simultaneously in content, the processing of FIG. 10 is performed on the plurality of objects in parallel.

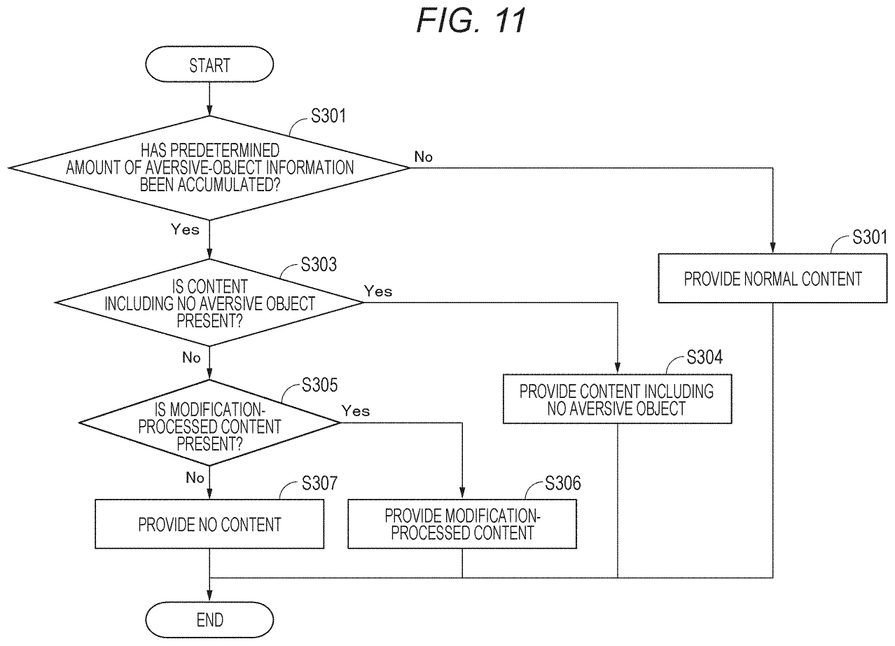

Next, with reference to the flowchart of FIG. 11, described will be processing of determining not-yet-viewed-and-listened-to content to be provided to the user, in the content determination unit 306 of the information processing device 300.

First, in step S301, it is determined, by the processing illustrated in FIG. 10, whether or not the accumulated amount of information regarding the aversive object is not less than a predetermined amount in the user database 304. In a case where the accumulated amount of information regarding the aversive object is less than the predetermined amount, the processing goes to step S302 (No in step S301).

Then, in step S302, the content determination unit 306 determines to provide the user with normal content. The normal content is typical content including or not including an aversive object. Thus, the content may or may not include an aversive object.

Otherwise, in a case where the accumulated amount of information regarding the aversive object is not less than the predetermined amount, the processing goes to step S303 (Yes in step S301). Next, in step S303, it is checked whether or not content including no aversive object is present. The presence of the content may be checked by referring to the content database 301 or by inquiring the distribution server 200. In the case of referring to the content database 301, it is necessary to periodically update the content database 301 to store in advance, in the content database 301, the information regarding the content having stored by the distribution server 200.

In a case where the content including no aversive object is present, the processing goes to step S304 (Yes in step S303). Then, the content determination unit 306 determines to provide the user with the content including no aversive object, as not-yet-viewed-and-listened-to content. The content including no aversive object is not content subjected to modification processing, but is content including no aversive object, as the original content data.

Otherwise, in a case where the content including no aversive object is absent, the processing goes to step S305 (No in step S303). Next, in step S305, it is determined that content subjected to modification processing or content that can be set to a state including no aversive object by the modification processing is present.

In a case where the content subjected to the modification processing or the content that can be set to the state including no aversive object by the modification processing, the processing goes to step S306 (Yes in step S305). The content determination unit 306 determines to provide the user with the content subjected to the modification processing or the content that can be subjected to the modification processing and can be set to the state including no aversive object by the modification processing, as not-yet-viewed-and-listened-to content. Otherwise, in a case where the content subjected to the modification processing is absent, the processing goes to step S307 (No in step 305), and the content determination unit 306 determines that no content to be provided to the user is present.

In such a manner, determined can be the not-yet-viewed-and-listened-to content to be provided to the user.

[1-5-3. Modification Processing to Details of Content]

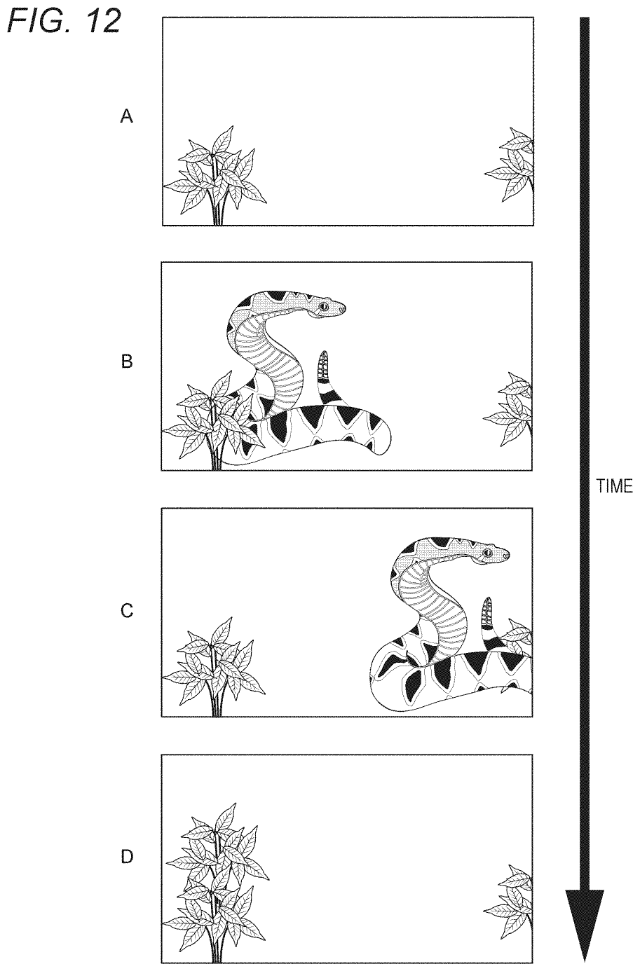

Next, modification processing to an object appearing in content will be described with reference to FIGS. 12 to 16. Here, a case where an aversive object is a snake will be described as an example.

FIG. 12 illustrates a frame A, a frame B, a frame C, and a frame D of the original data of content not subjected to modification processing, and illustrates a moving image in which the snake appears in the frame B, moves from the frame B to the frame C, and disappears in the frame D.

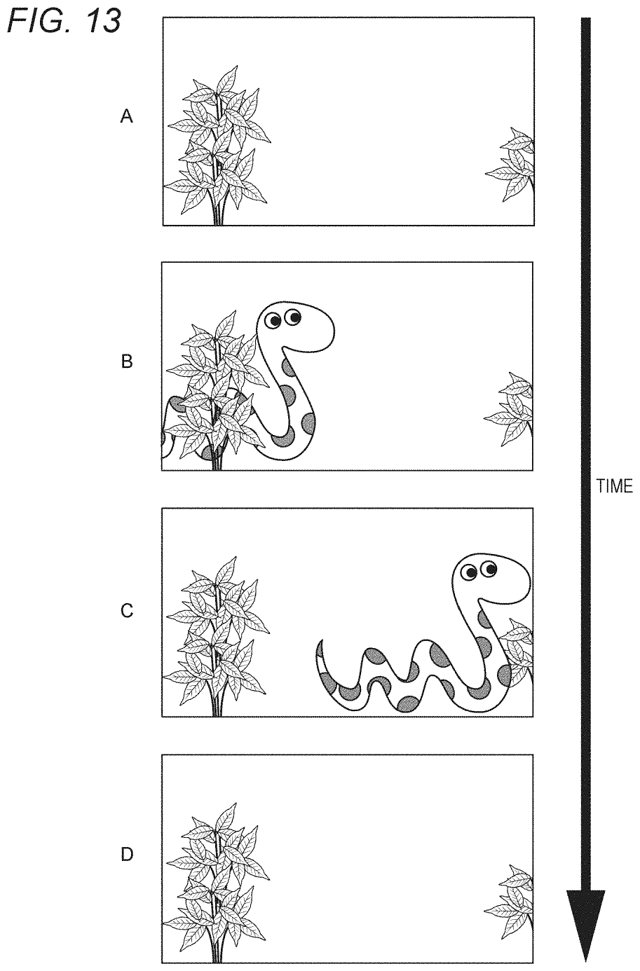

In a first modification example of FIG. 13, modification processing of substituting the snake as the aversive object with a deformed snake is performed. Substitution of the aversive object with a deformed character in such a manner enables reduction of the sense of aversion when the user views and listens to the content, while maintaining the story and flow of the content.

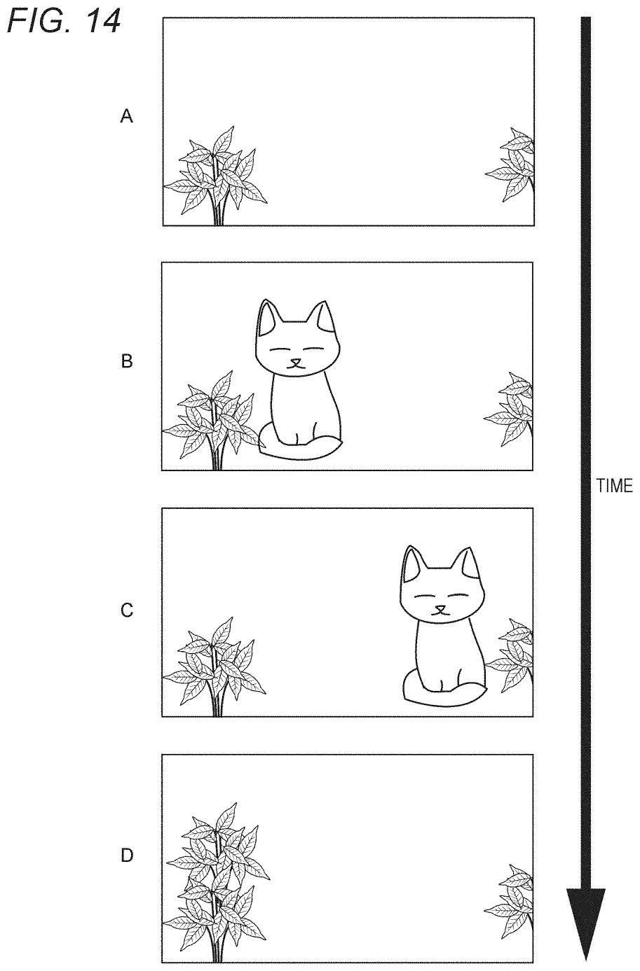

In a second modification example of FIG. 14, a modification is made to substitute the snake as the aversive object with a character different from the snake. Substitution of the aversive object with another character or the like in such a manner enables prevention of giving the user the sense of aversion at the time of viewing of and listening to the content. For the other character to be substituted in this case, used may be an animal, a created character, an icon, or the like that typically gives an impression other than discomfort, such as being cute, pretty, or beautiful.

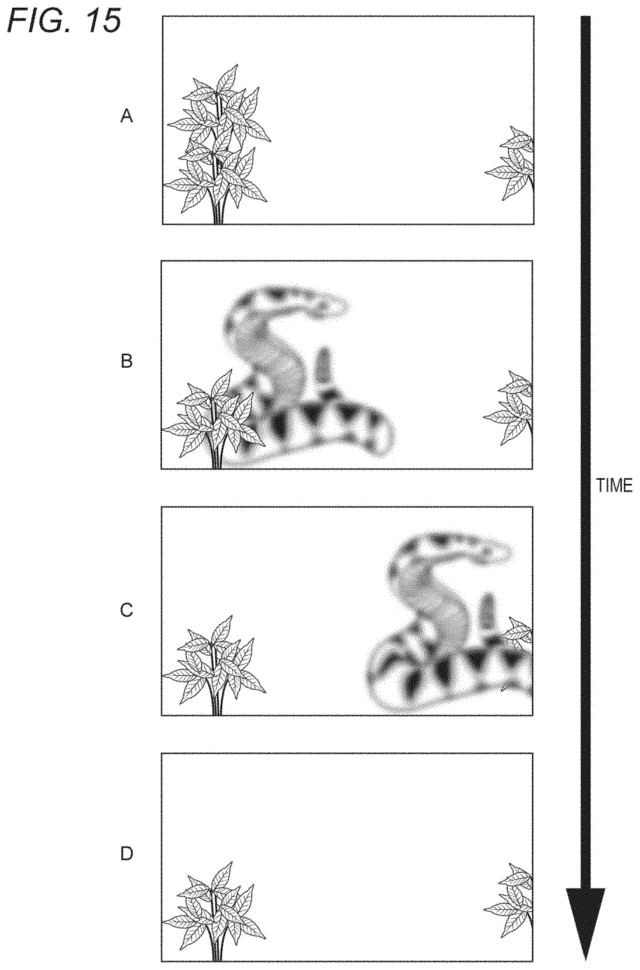

In a third modification example of FIG. 15, the snake as the aversive object is subjected to blurring processing. Blurring the aversive object in such a manner enables reduction of discomfort when the user views and listens to the content, while maintaining the story and flow of the content. Note that the blurring processing is processing for making a reduction in visual recognition on the aversive object, and thus another piece of processing for making a reduction in the visual recognition, such as mosaicing may be used.

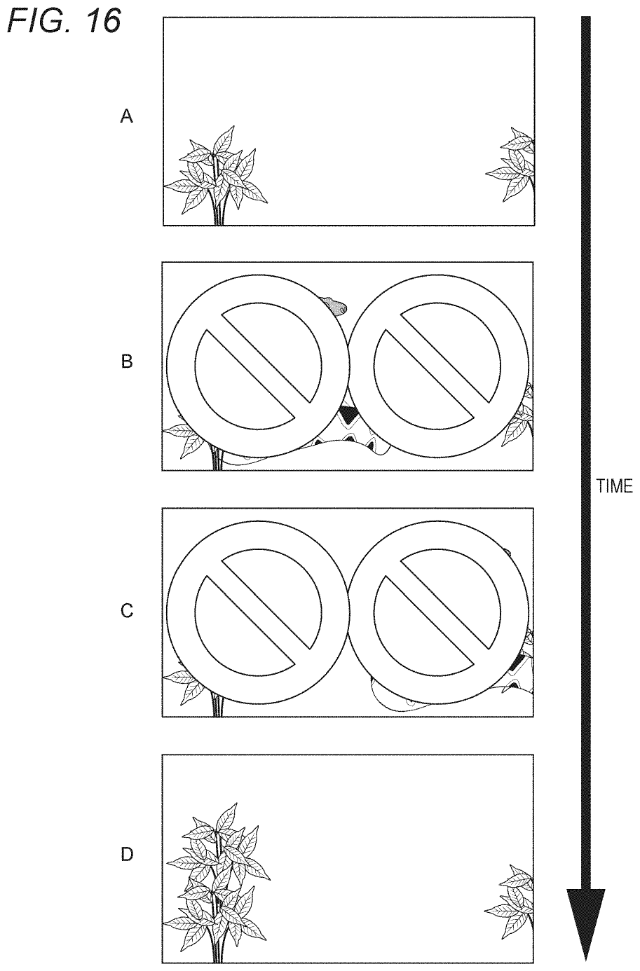

In a fourth modification example of FIG. 16, a modification is made to delete the frame B and the frame C in which the snake as the aversive object appears. Deletion of the frames in which the aversive object appears in such a manner enables prevention of giving the user the sense of aversion at the time of viewing of and listening to the content.

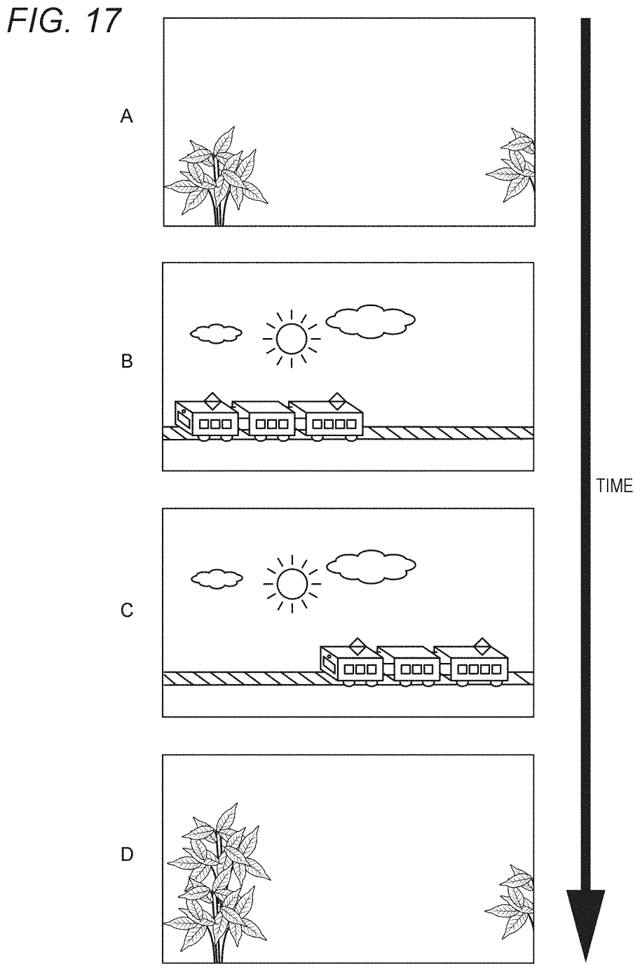

In a fifth modification example of FIG. 17, a modification is made to substitute each of the frame B and the frame C in which the snake as the aversive object appears with a frame of another scene. Substitution of the scenes in which the aversive object appears with the other different scenes in such a manner enables prevention of giving the user the sense of aversion at the time of viewing of and listening to the content.

In order to perform such modification processing, for content having been created, an object appearing in the content is specified in advance, for example, by known scene analysis processing, known object detection processing, or a person seeing and checking the content. Then, it is determined that processed content is provided by the information processing device 300. The aversive object for the user is subjected to modification processing and the processed content is provided to the user.

In addition, for CG content to be newly produced, a substitute object for an object highly likely to be an aversive object is prepared in advance. Then, it is determined that processed content is provided by the information processing device 300 and if a request for providing the processed content is made by the user, the object highly likely to be an aversive object is substituted with the substitute object and rendered, so that the processed content is created and provided to the user.

Modification processing may be performed in the distribution server 200. The distribution server 200 may hold the content data subjected to the modification processing in addition to the original content data, and may provide either the modification-processed content data or the original content data in accordance with a request. In this case, the distribution server 200 receives information regarding the aversive object, that is, the object to be modified, from the information processing device 300, and performs the modification processing on the basis of the information. Alternatively, the modification processing may be performed in the information processing device 300 having received content data from the distribution server 200. Further, content data and data for modification processing may be transmitted to the terminal device 100 in content distribution from the distribution server 200, and modification processing may be performed in the terminal device 100. In this case, the distribution server 200 receives information regarding the aversive object, that is, the object to be modified, from the information processing device 300, and creates data for the modification processing on the basis of the information. In a case where the modification processing is performed with the distribution server 200 or the information processing device 300, it is considered that the modification processing is performed by a content creating company having a right for content, a business operator having permission for modification from the content creating company, or the like.

Note that the modification processing method to be adopted may be determined on the basis of which threshold for the aversive level has been exceeded in the aversive levels set as severe, serious, moderate, and mild and the object has approval as an aversive object.

For example, for an object that has approval as an aversive object because the threshold for severe in aversive level has been exceeded, a modification is made to delete or substitute the object with another object, without appearing in the content at all. This would mean that the user would not want to see the object to which the user has shown the aversive reaction of severe in aversive level even if the object was deformed. In addition, for an object that has approval as an aversive object because the threshold for mild in aversive level has been exceeded, a modification is made to substitute the object with a deformed object as in the first example. This would mean that in the case of mild in aversive level, the user would be able to see the deformed object.

The processing according to the present technology is performed as above. In the above embodiments, in response to a request for providing content, from the user to the information processing device 300, the information processing device 300 recognizes the user and checks an aversive object for the user. The information processing device 300 requests the distribution server 200 for content including the aversive object for the user subjected to modification processing, and the distribution server 200 transmits the content to the information processing device 300. Then, the information processing device 300 distributes the content to the terminal device 100 of the user.

The content is provided in such a manner, so that the personal information regarding the user called the aversive object does not reach the distribution server 200. Thus, the content can be provided without spreading the personal information more than necessary.

As an effect of the present technology on the content provider, provided can be content without giving the sense of aversion to users in accordance with the preference of each user. Further, provided can be a wide range of content to a user who is negative about content consumption and bad at many objects. Furthermore, provided can be content to a user who has conventionally rejected only for a title, a package, or a plot. Prevented can be the occurrence of a user who has felt intense discomfort once and will never use the service again. Still furthermore, discovered and widely provided can be excellent content likely to be disliked by a user.

As an effect of the present technology on a user, the user can view and listen to content at ease assuming that there is no possibility that the user has a sense of aversion to an object that the user is bad at. In addition, it is difficult for the user to predict an object appearing in content. However, according to the present technology, the user does not have to see an object that the user dislikes without noticing. Further, the user can come in contact with new content that the user has not been able to come in contact with because the content includes content that the user dislikes. Furthermore, the user can reencounter excellent content of a genre that has once been considered as dislike and the user has a prejudice against.

In addition, content to be provided next can be determined in accordance with the aversive reaction of the user to the viewed-and-listened-to content viewed and listened to immediately before. Further, the user's emotion can be estimated on the basis of a reaction of the user, and content to be provided to the user can be determined on the basis of the circular estimation result. For example, in a case where a smile is detected in an image captured by the camera 510 and the user is estimated to be in a good mood, it enables to provide content in which an aversive object appears not more than a predetermined number of times. Alternatively, in a case where the user is estimated to be depressed from the biometric information, content in which any aversive object appears even once will not be provided, for example.

### 2. Applications

In the above embodiments, content is a moving image, and an object is a specific living organism, object, or the like. The present technology, however, is applicable to various kinds of content such as music, a movie, animation, a game, an environmental video, and a live-action video.

In the case of music or sound, for example, lines, sound of scratching glass, or music that causes anxiety in moving image content can be substituted or muted.

In addition, the details of part of the content in the present technology may be not only an object but also a scene, and the present technology is also applicable to a scene in the content. For example, a scene such as a violent scene, a scene with blood, a differential scene, a scene including black humor, or a scene in which a sexual scene appears can be substituted with another scene or deleted. A scene can be subjected to known scene analysis processing, or in a case where a specific object appears continuously over a predetermined number of frames (or for a predetermined duration), a range including the frames may be regarded as a scene. Such a scene also corresponds to the detail of the content in the claims.

In addition, the present technology can also be used for adjustment of examination results of games rated by Computer Entertainment Rating Organization (CERO).

In the case of a game, more pieces of reaction information regarding the user can be acquired and reflected in determination of content to be provided. For example, provision of a pressure-sensitive sensor, a gyro sensor in a controller enables detection of the strength of input to the button, the time lag of input, a motion such as shaking of a hand holding the controller, or dropping or hitting of the controller. Further, acquired can be reaction information resulting from capturing of the facial expression or movement of the user by a camera for a virtual reality (VR) game.

Furthermore, in a case where content is a game, a character or a background appearing in the game can be easily substituted with another character or background by replacement with a 3D model (polygon, texture). Specifically, a gun may be substituted with a water gun, or a sword may be substituted with a paper fan, for example.

An information bank can also be used in carrying out the present technology. An information bank is a business that manages data by utilizing a system such as a personal data store (PDS) on the basis of a contract or the like regarding data utilization with an individual, a company, an association, an organization, or the like, and provides the data to a third party after determining validity on behalf of the individual or the like on the basis of an instruction by the individual or the like or a condition designated in advance. The information bank stores data transmitted from a data provider and provides the data in response to a request from a data user. The information bank gives an incentive obtained from the data user to the data provider in accordance with the data provision to the data user, and obtains part of the incentive.

Specifically, information regarding viewing of and listening to the content by the user and information that can be used to acquire the aversive reaction at the time of viewing of and listening to the content can be acquired from the information bank.

Further, performed can be association and management of the aversive reaction of the user, the aversive content, and the content information and the object information in the content database 301.

Furthermore, performed can be collection and management of information regarding the title of content, an object appearing in the content, and a scene in the content.

Still furthermore, provided to the information bank can be aversive-reaction information regarding the user acquired in the processing in the terminal device 100 described with reference to FIG. 9.

When the user sees content for which the user has a sense of aversion, post traumatic stress disorder (PTSD) may develop. Therefore, in a case where the present technology is put into practical use, in actual use, a medical worker may check whether setting of the aversive object, the aversive reaction, and the aversive level is inappropriate, and may perform its correction.

For example, in a case where a spider appears in the content and is inconspicuous such as a small proportion occupied on the screen, the aversive level may be lowered (to mild or moderate), or in a case where a snake appears in the content and is shown on the entire screen, and moves to jump toward the camera 510, the aversive level is raised (to serious or severe). This is because the influence of an object on the person seeing the content varies depending on how the object appears in the content.

Further, even for the same object, the influence may vary depending on the state of the user and the environment at the time of viewing of and listening to.

The present technology is also effective for users with PTSD. For example, a diagnosis can be made without noticing the possibility of PTSD. In addition, content suitable for recovery from PTSD can be distributed, and such a user can view and listen to the content. Further, obtained can be an opportunity to overcome what does not cause PTSD but is bad at.

Furthermore, the present technology is also effective for medical workers who treat PTSD. For example, a diagnosis for a potential PTSD patient can be made. Still furthermore, provided can be content suitable for rehabilitation of a patient diagnosed as PTSD. Still furthermore, given can be advice for overcoming to a person who has something that is not PTSD but is bad at.

### 3. Modifications

The embodiments of the present technology have been specifically described above. The present technology, however, is not limited to the above embodiments, and thus various modifications based on the technical idea of the present technology can be made.

The information processing device 300 may operate in a server as described in the embodiments, or may operate in the cloud, the terminal device 100, or the distribution server 200.

The device used for the user to view and listen to content and the device for transmitting aversive-reaction information regarding the user to the information processing device 300 have been described as the same device, but may be different devices. For example, the user may view and listen to content with a television, and may transmit aversive-reaction information to the information processing device 300 with a personal computer, a smartphone, a smart speaker, or the like.

Note that the present technology can also adopt the following configurations.

(1)

An information processing device configured to determine whether to perform modification to a detail of part of not-yet-viewed-and-listened-to content for a user, on the basis of a reaction of the user to viewed-and-listened-to content.

(2)

The information processing device according to (1) described above, in which the reaction corresponds to a reaction indicating an aversive emotion of the user to the viewed-and-listened-to content.

(3)

The information processing device according to (1) or (2) described above, in which the detail is determined on the basis of the reaction of the user at time of viewing of and listening to the viewed-and-listened-to content and a reproduction position of the viewed-and-listened-to content.

(4)

The information processing device according to (3) described above, in which a number of times of the reaction to the detail are counted and when the number of times of the reaction exceeds a threshold, the detail is determined to be subjected to the modification.

(5)

The information processing device according to any of (1) to (4) described above, in which as the modification, the detail is deformed.

(6)

The information processing device according to any of (1) to (4) described above, in which as the modification, the detail is substituted with another detail.

(7)

The information processing device according to any of (1) to (4) described above, in which as the modification, the detail is subjected to processing of making a reduction in visual recognition on the detail.

(8)

The information processing device according to any of (1) to (4) described above, in which as the modification, the detail is deleted.

(9)

The information processing device according to any of (1) to (8) described above, in which the detail corresponds to an object in the not-yet-viewed-and-listened-to content.

(10)

The information processing device according to any of (1) to (9) described above, in which the detail corresponds to a scene in the not-yet-viewed-and-listened-to content.

(11)

The information processing device according to any of (1) to (10) described above, in which the modification is performed to the not-yet-viewed-and-listened-to content provided from a distribution server.

(12)

The information processing device according to any of (1) to (11), in which the modification is performed in a distribution server that distributes the not-yet-viewed-and-listened-to content.

(13)

The information processing device according to any of 1) to (11) described above, in which the modification is performed in a terminal device that outputs the not-yet-viewed-and-listened-to content for presentation to the user.

(14)

The information processing device according to any of 1) to (13) described above, in which the reaction is acquired on the basis of an image resulting from capturing of the user by a camera.

(15)

The information processing device according to any of 1) to (14) described above, in which the reaction is acquired on the basis of biometric information regarding the user acquired by a sensor.

(16)

The information processing device according to any of 1) to (15), in which the reaction is acquired on the basis of a voice of the user acquired by a microphone.

(17)

The information processing device according to any of 1) to (16), in which the reaction is acquired on the basis of input information regarding the user to an input device that issues an input instruction to a terminal device that outputs the viewed-and-listened-to content.

(18)

An information processing method including: determining whether modification is to be performed to a detail of part of not-yet-viewed-and-listened-to content for a user, on the basis of a reaction of the user to viewed-and-listened-to content.

(19)

An information processing program for causing a computer to perform an information processing method including determining whether modification is to be performed to a detail of part of not-yet-viewed-and-listened-to content for a user, on the basis of a reaction of the user to viewed-and-listened-to content.

### REFERENCE SIGNS LIST

100 Terminal device
200 Distribution server
300 Information processing device
510 Camera
520 Sensor device
530 Microphone
540 Controller

1. An information processing device configured to determine whether to perform modification to a detail of part of not-yet-viewed-and-listened-to content for a user, on a basis of a reaction of the user to viewed-and-listened-to content.

2. The information processing device according to claim 1,
wherein the reaction corresponds to a reaction indicating an aversive emotion of the user to the viewed-and-listened-to content.

3. The information processing device according to claim 1,
wherein the detail is determined on a basis of the reaction of the user at time of viewing of and listening to the viewed-and-listened-to content and a reproduction position of the viewed-and-listened-to content.

4. The information processing device according to claim 3,
wherein a number of times of the reaction to the detail are counted and when the number of times of the reaction exceeds a threshold, the detail is determined to be subjected to the modification.

5. The information processing device according to claim 1,
wherein as the modification, the detail is deformed.

6. The information processing device according to claim 1,
wherein as the modification, the detail is substituted with another detail.

7. The information processing device according to claim 1,
wherein as the modification, the detail is subjected to processing of making a reduction in visual recognition on the detail.

8. The information processing device according to claim 1,
wherein as the modification, the detail is deleted.

9. The information processing device according to claim 1,
wherein the detail corresponds to an object in the not-yet-viewed-and-listened-to content.

10. The information processing device according to claim 1,
wherein the detail corresponds to a scene in the not-yet-viewed-and-listened-to content.

11. The information processing device according to claim 1,
wherein the modification is performed to the not-yet-viewed-and-listened-to content provided from a distribution server.

12. The information processing device according to claim 1,
wherein the modification is performed in a distribution server that distributes the not-yet-viewed-and-listened-to content.

13. The information processing device according to claim 1,
wherein the modification is performed in a terminal device that outputs the not-yet-viewed-and-listened-to content for presentation to the user.

14. The information processing device according to claim 1,
wherein the reaction is acquired on a basis of an image resulting from capturing of the user by a camera.

15. The information processing device according to claim 1,
wherein the reaction is acquired on a basis of biometric information regarding the user acquired by a sensor.

16. The information processing device according to claim 1,
wherein the reaction is acquired on a basis of a voice of the user acquired by a microphone.

17. The information processing device according to claim 1,
wherein the reaction is acquired on a basis of input information regarding the user to an input device that issues an input instruction to a terminal device that outputs the viewed-and-listened-to content.

18. An information processing method comprising:
determining whether modification is to be performed to a detail of part of not-yet-viewed-and-listened-to content for a user, on a basis of a reaction of the user to viewed-and-listened-to content.

19. An information processing program for causing a computer to perform an information processing method comprising
determining whether modification is to be performed to a detail of part of not-yet-viewed-and-listened-to content for a user, on a basis of a reaction of the user to viewed-and-listened-to content.
